(19) United States
(12) Patent Application Publication
(10) Pub. No.: US 2026/0029074 A1
(43) Pub. Date: Jan. 29, 2026

(54) QUICK CONNECTOR WITH LOW INSERTION FORCE RETAINER

(71) Applicant: Cooper-Standard Automotive Inc., NORTHVILLE, IL (US)

(72) Inventors: Thomas Capua, Midland, MI (US); Kenneth Gocha, Flint, MI (US); Tisiphone A. Titus, Warren, MI (US)

(73) Assignee: Cooper-Standard Automotive Inc., NORTHVILLE, MI (US)

(21) Appl. No.: 19/273,670

(22) Filed: Jul. 18, 2025

Related U.S. Application Data
(60) Provisional application No. 63/674,889, filed on Jul. 24, 2024.

(51) Int. Cl. F16L 37/088

(52) U.S. Cl. CPC F16L 37/0885

(57) ABSTRACT

A connector for coupling a tube to a receptacle includes an endform formed on the end of the tube that is arranged to be inserted into the receptacle in a mounting position and slidable to a latched position. A retainer embraces the receptacle and includes first and second legs extending into the receptacle. The legs each have a cross section that has a first minor axis that is smaller than a second major axis. The endform engages the legs first minor axis urging the legs into a spread condition while the endform is sliding from the mounting position to the latched position. In the latched position the legs retract to a relaxed condition and are captured in a groove in the end form.

### CROSS-REFERENCE TO RELATED APPLICATION AND PRIORITY CLAIM

This application claims priority under 35 U.S.C. § 119 (e) to U.S. Provisional Patent Application No. 63/674,889 filed on Jul. 24, 2024. This provisional application is hereby incorporated by reference in its entirety.

### TECHNICAL FIELD

The field relates to a quick connector for connecting a tube to a receptacle. More particularly, this disclosure relates to a quick connector having a wire retainer formed to minimize insertion forces when installing the tube to the receptacle.

### BACKGROUND

In fluid piping in which a tube, such as a pipe or a hose, is joined to another device such as a pump, tank or another tube, a connector may be used for joining the tube to the other device. The connector may have a tubular receptacle for receiving the tube. The tube may include an end with an upset portion arranged for a quick snap engagement with the receptacle to provide a locking relation between the tube and the receptacle. A wire retainer is often used in quick connectors that have a pair of engagement arms that extend through slots in the receptacle to capture the tube upset.

The wire retainer is made of a material that is harder than the tube or the upset on the tube. As the tube is inserted into the receptacle, the inwardly biased wire retainer is displaced outward by the upset to allow entry of the tube into the receptacle. Upon the full insertion of the tube, the wire retainer then snaps back to engage the upset in a locking relationship that captures the tube to the receptacle preventing the tube from being pulled out of the receptacle.

Quick connectors of the type described above have the disadvantage that the tube becomes difficult to install into the receptacle due to the high ergonomic force required to displace the wire retainer. Making the wire retainer from a more bendable softer material has a disadvantage in that the wire retainer fails in the ability to robustly retain the tube to the receptacle.

Therefore, it would be desirable to provide a quick connector that has a wire retainer that has a low ergonomic insertion force while still being robust enough to retain the tube to the receptacle.

### SUMMARY

In a first aspect of the embodiment a connector for coupling to a tube is disclosed that comprises a receptacle having an interior cavity arranged to receive the tube. A retainer embraces the receptacle and has at least a first leg positioned in a cavity located in the interior of the receptacle. The retainer engages the tube when the tube is inserted into the cavity, wherein the first leg has a cross-section that has a first minor axis that is smaller than a second major axis.

In a second aspect of the embodiment an assembly of a connector and a tube is disclosed that comprises a receptacle and an endform formed on the end of the tube. The endform includes a groove extending about the periphery of the endform. The endform is inserted into a cavity within the receptacle in a mounting position and is slidable into a latched position. A retainer embraces the receptacle and has a first and a second leg extending into the cavity, each leg having a cross section that has a first minor axis and a second major axis. The endform engages the first and second legs first minor axis urging the first and second legs into a spread condition while the endform is sliding from the mounting position into the latched position, wherein in the latched position the first and second legs of the retainer are captured in the groove when the first and second legs retract to a relaxed condition.

In a third aspect of the embodiment a process for coupling a tube to a receptacle is disclosed comprising forming an endform on an end of the tube. The endform having a groove about the periphery of the endform and locating the endform in a cavity within the receptacle in a mounting position, wherein the endform is slidable into a latched position. The process further includes installing a retainer having a first and a second legs in the cavity, wherein each leg has a cross section that has a first minor axis and a second major axis and sliding the endform from the mounting position to the latched position causing the endform to engage the first and second legs minor axis that urge the first and second legs into a spread condition while the endform is traversing from the mounting position to the latched position. In the latched position the major axis of each of the first and second legs are captured by parallel walls forming the groove when the first and second legs retract to a relaxed condition.

### BRIEF DESCRIPTION OF THE DRAWINGS

For a more complete understanding of this disclosure, reference is now made to the following description, taken in conjunction with the accompanying drawings, in which:

FIG. 1 illustrates an example exploded isometric view of a disassembled quick connector and tube;

FIG. 2 illustrates an isometric view of a prior art wire retainer;

FIG. 2A illustrates a cross-section through the prior art wire retainer of FIG. 2;

FIG. 3 illustrates an isometric view of a low insertion force wire retainer in accordance with the present disclosure;

FIG. 3A illustrates a cross-section through the wire retainer of FIG. 3;

FIG. 4 illustrates an elevational sectional view of the example quick connector with the endform in a mounting position;

FIG. 5 illustrates an elevational sectional view of the example quick connector, with the endform in a transitional position;

FIG. 6 illustrates an elevational sectional view of the example quick connector with the endform in a latched position; and

FIG. 7 illustrates a graph that compares the insertion forces of the prior art wire retainer and the low insertion force wire retainer.

### DETAILED DESCRIPTION

All figures serve illustrative purposes only and are not intended to limit the scope of the present invention. The drawings are generally to scale, but some features may not be true to scale and serve to emphasize certain details of the various aspects of the invention. Common items between different embodiments of the figures have common reference numerals. It should be noted that for purposes of clarity, the quick connector of the present disclosure is shown with its longitudinal extent position in a horizontal plane and the terms “top,” “bottom,” have been used in describing the connector body. However, in use, the quick connector coupling can reside in any orientation without regard to the horizontal and vertical planes and “top,” “bottom,” “sides,” and “lateral” are thus used in relation to the figures and illustrations herein.

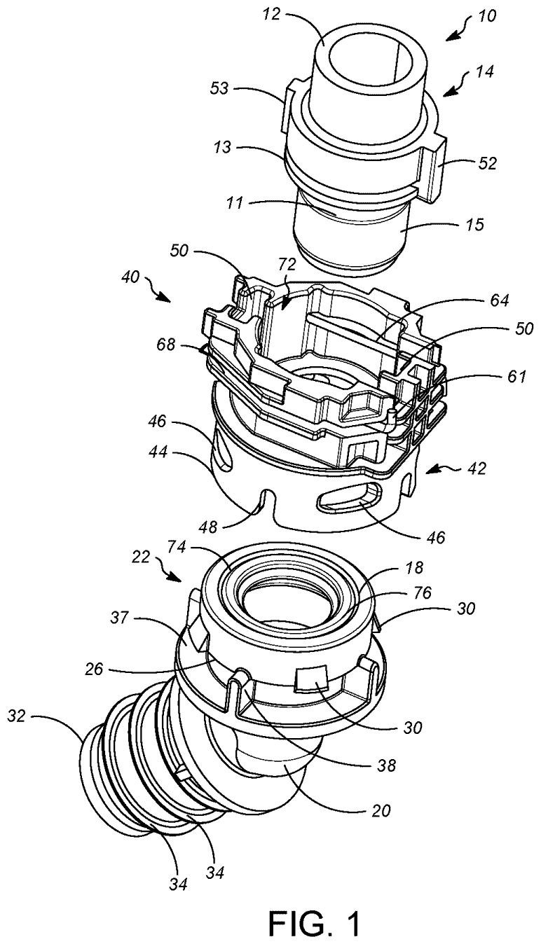

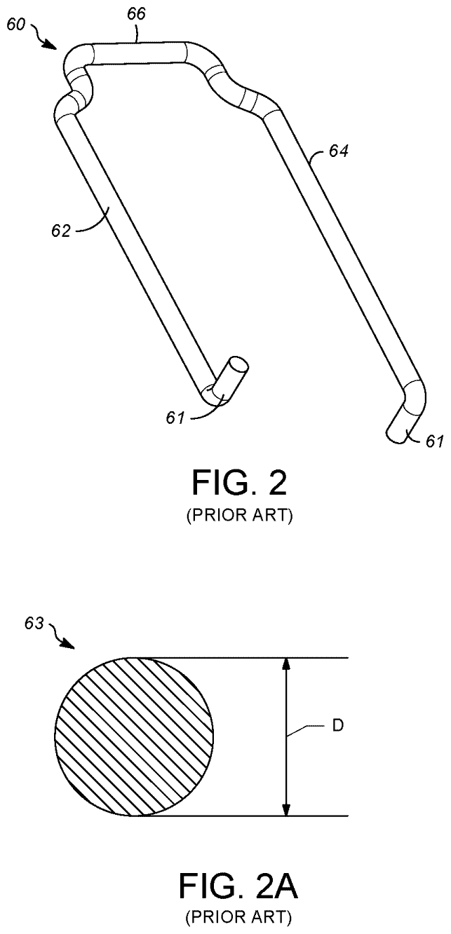

An exploded view of an example quick connector 10 for coupling a tube 12 to another device is illustrated in FIGS. 1 and 2. The other device may be another tube, or it could be a tank or a pump, for example. The tube 12 is partially shown in FIG. 1 and includes an endform 14 secured on an end of the tube 12. Tube 12 may be a hose, a pipe, or fluidly communicate with another device. The endform 14 may include a groove 13. The example quick connector 10 may be tubular defining a hollow passage through which a fluid may pass to or from the tube 12. In an aspect, the quick connector 10 may have an annular configuration made up of hollow cylindrical segments.

The quick connector 10 includes a receptacle for receiving the endform 14 of tube 12. The receptacle may comprise two separate pieces. The first piece of the receptacle is socket 22. The socket 22 has a female end 18 and a coupling end 20. The female end 18 of the socket 22 receives an end portion of the tube 12. Specifically, the socket 22 may receive the end portion 15 of endform 14 of the tube 12 therein. The socket 22 includes an annular outer wall 26 surrounding the female end 18. An annular interior groove 74 in the socket 22 retains an elastomeric sealing assembly, for example an O-ring 76. When tube 12 is inserted into the socket 22, the O-ring 76 squeezes around end portion 15 of the tube 12 preventing the leakage of fluid passing therethrough.

A latch 30 may be fashioned on the outer wall 26. In an aspect, a plurality of latches 30 may be fashioned on the outer wall 26. The latches may be rectangular and include a chamfered surface that extends obliquely outward from outer wall 26. An annular brim 37 extends about the lower periphery of outer wall 26 below latches 30. Brim 37 further includes a projection 38 extending vertically from brim. In an aspect, a plurality of projections 38 may be fashioned on the brim 38.

The coupling end 20 may be for coupling the connector 10 to another device. The coupling end 20 may include a male stem 32 for mating with a receptacle of another device. The male stem 32 may include one or more barbed flanges 34 that can be friction fitted into another tube, for example, to couple the connector 10 to the other tube. In this embodiment, fluid from the tube 12 can pass from the tube through the female end 18 of socket 22 and through the male stem 32 of the coupling end 20 of the connector 10 and into the other tube installed over stem 32 or vice-versa. The coupling end 20 may extend at any convenient angle applicable to the intended use of receptacle, which means that the coupling end 20 can have a feature, where the male stem 32, can have a longitudinal axis that may extend from the axis of the female end 18 obliquely, defining an angle between coupling end 20 and female end 18 that is not equal to 180 degrees.

The second piece of the receptacle is a modular head 40. The modular head 40 has a mating end 42 with an annular outer wall 44 extending about the periphery of modular head 40 on its lower end. An opening 46 is located on the outer wall 44 extending through the outer wall. Additionally, the outer wall 44 includes a projection receiver 48 adapted to receive therein an associated projection 38 when the modular head 40 is installed on socket 22. In an aspect, a plurality of openings 46 and projection receivers 48 may be fashioned about the periphery of outer wall 44 of mating end 42.

The modular head 40 mates with the socket 22 to provide the receptacle of the quick connector 10. The mating end 42 of the modular head 40 is arranged to be inserted over the outer wall 26 of the socket 22. The mating of the modular head 40 to socket 22 is made by aligning a projection 38 with an associated projection receiver 48 and the modular head forced downward toward brim 37 to allow the chamfered portions of latches 30 to ride against the inside surface of the outer annular wall 44 until they are received within an associated opening 46, creating a snap-fit mechanical connection between the modular head 40 and socket 22. The mating end 42 of modular head 40 rests on brim 37 when the modular head 40 is fully inserted on socket 22. The socket 22 and the modular head 40 may be separately molded of a thermoplastic material such as polyamide or polyphthalamide.

The modular head 40 may further include an indexing member 50 for alignment with an indexing form 52 on the endform 14 of the tube 12. The indexing member 50 on the modular head 40 may be a groove and the indexing form 52 a tab extending from endform 14. Tab 52 is arranged to be received in groove 50 to ensure proper alignment while inserting the endform 14 into the modular head 40. In an aspect, the tab could be the indexing member 50 on the modular head 40 and the groove could be the indexing member 52 on the endform 14 of the tube 12. The endform may omit an indexing member 52, and it may also include an additional indexing member 53.

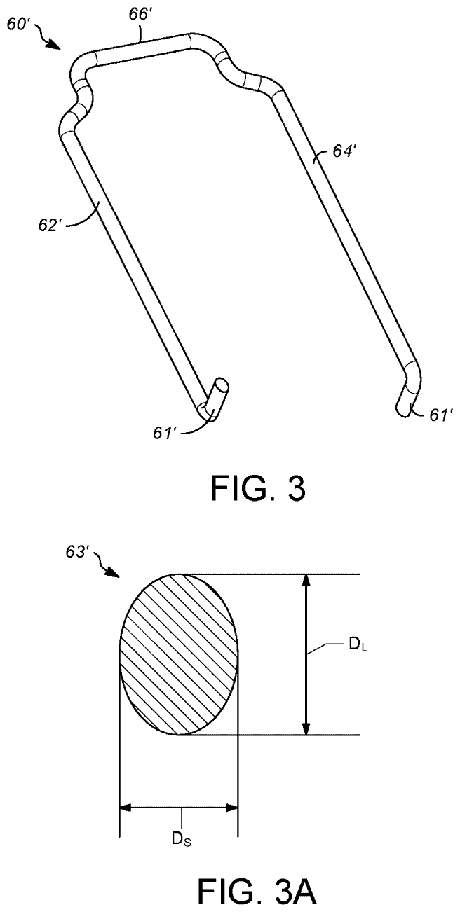

A wire retainer 60 embraces the modular head 40. The wire retainer 60 best seen at FIG. 2 and FIG. 3 has a U-shaped configuration comprising two opposed legs 62, 64 extending from a bight 66. The wire retainer 60 is retained on the modular head 40 when mated to the socket 22, but it could be retained directly on the socket 22. The wire retainer 60 may be made of a metal material such as, for example, stainless steel. The bight 66 embraces an outer wall 68 of the modular head 40, however legs 62, 64 extend through slots in wall 68, permitting the legs to extend into the interior cavity 72 of the modular head 40 when the retention clip 60 is in a relaxed condition. Each leg 62, 64 terminates in an upturned prong 61 which are assembled onto the modular head 40 by passing through a slot contiguous and orthogonal to the slots in wall 68.

The endform 14 further includes an annular ramped surface 11 adjacent the groove 13 that tapers inwardly to the end portion 15. The endform 14 is installed in the receptacle by positioning the end portion 15 into interior cavity 72 and lowering the endform 14 axially into interior cavity 72 until the annular ramped surface 11 engages legs 62, 64 of retention clip 60. As endform 14 is further moved into the interior cavity 72 the ramped surface 11 urges each leg 62, 64 transversely outward of the slots formed in wall 68. The legs are urges further apart as the endform is axially lowered into the interior cavity 72 until the maximum transverse distance of the ramped surface 11 is encountered wherein both legs 62, 64 fall-off of the ramped surface 11 and retract to their original relaxed condition to be retained within annular groove 13 of endform 14.

The prior-art wire retainers 60 currently used in the quick connectors 10 described above, are typically formed using a metal wire having a round cross-section, as shown in FIG. 2A. The round cross section typically has a uniform diameter D of 1.5 mm to 2.0 mm, the diameter dependent on the size and type of the quick connector 10. The wire retainers 60 having a round 63 cross-section provide robust retention of the endform 14 to the receptacle when installed, however, the round 63 cross-section requires a substantial amount of force to displace the legs 62, 64 when installing endform 14 into the receptacle.

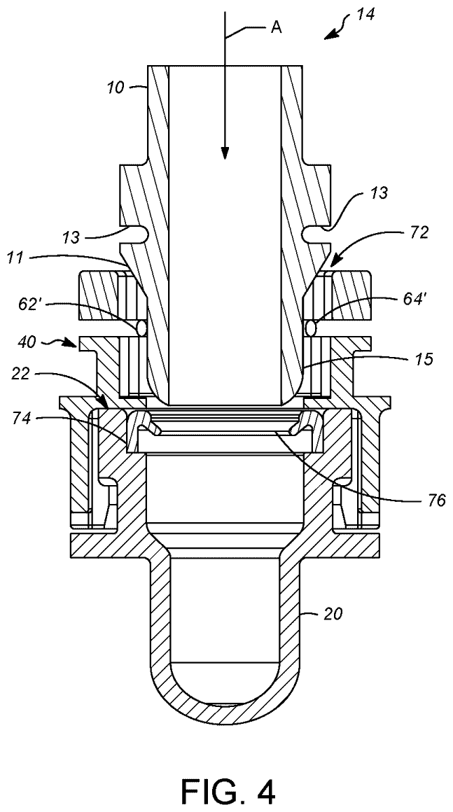

FIG. 3 and FIG. 3A illustrate a low insertion force wire retainer 60′ of the present disclosure. The low insertion force wire retainer 60′ has a cross-section that is an oval 63′. The oval 63′cross-section is defined by a short or minor axis DS that is 20% to 30% smaller than the long or major axis DL. The wire retainer 60′ may have all of its parts formed as an oval 63′, for example the bight 66′, the legs 62′, 64′ and the prongs 61′. Or, it may only have the legs 62′, 64′ shaped as an oval 63′, with the bight 66′ and prongs 61′ retaining a round cross-section. The wire retainer legs 62′, 64′ are installed in the socket head 40 orienting the short diameter axis DS toward the interior cavity 72 and the long diameter axis DL parallel with the longitudinal axis of the interior cavity 72, as shown in FIGS. 4, 5 and 6

The smaller diameter DS of the wire retainer 60′ and specifically short diameter DS of legs 62′ and 64′ are formed to have a diameter of 1.1 mm to 1.3 mm. This reduced diameter reduces the amount of force required to transversely displace legs 62′, 64′ by the ramped surface 11 of the endform 14. The long diameter axis DL of each oval leg 62′ 64′ however retains a diameter of 1.5 mm to 2.0 mm and therefore provides the same retention force of the round 63 cross-section wire retainer 60 when an axial force is applied to them.

FIG. 4 illustrates a sectional view of endform 14 and the receptacle in a mounting position. In the mounting position the endform 14 is positioned within the interior cavity 72 of modular head 40 before engagement of legs 62′ 64′ with the ramped surface 11 of endform 14. In the mounting position, portion 15 is inserted axially into the interior cavity 72 between the legs 62′, 64′ in direction A. In the mounting position, legs 62′, 64′ are in a relaxed condition and extend through the interior cavity 72 of the modular head 40. The spacing between legs 62′ and 64′ allows the end portion 15 to locate and travel between each leg 62′ and 64′ toward the socket 22. In the mounting position the end portion 15 rests just above O-ring seal 76.

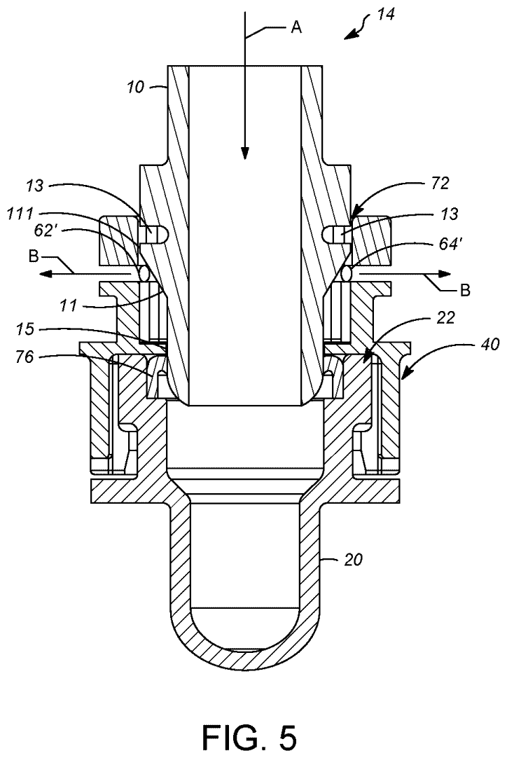

Further axial displacement of the endform 14 in direction A causes the endform 14 and the receptacle to enter the transitional position shown in FIG. 5. In the transitional position the end portion 15 enters and seals against the O-ring 76. The ramped surface 11 engages each leg 62′, 64′ which moves each leg in direction B that is transverse to the axial insertion direction A. The insertion force in axial direction A causes each leg 62′, 64′ to be displaced transversely in direction B by the camming action of ramped surface 11. The insertion force in direction A becomes larger as the end portion 15 further enters the O-ring 76 in socket 22. Each leg 62′, 64′ is displaced transversely in direction B to a maximum extent when each leg 62′, 64′ reaches an edge 111 of the ramped surface 11. At edge 111 the insertion force applied to the endform 14 in direction A is at a maximum.

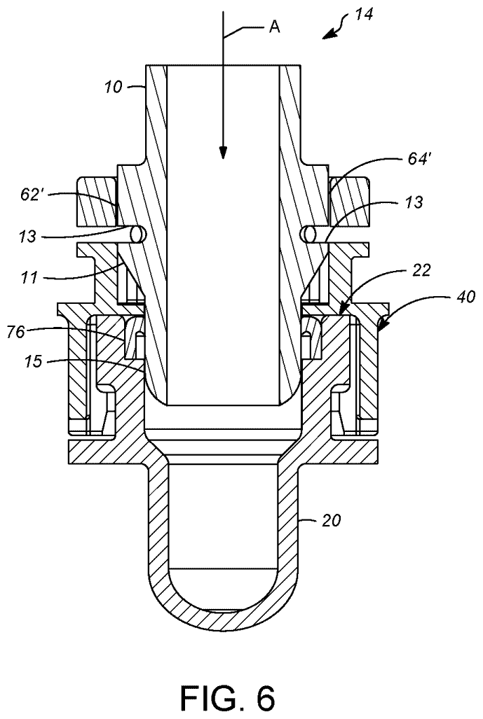

Further movement of the endform 14 in axial direction A causes each leg 62′, 64′ to fall-off edge 111 and into groove 13 and enter a latched position as is shown in FIG. 6. In the latched position, each leg 62′, 64′ returns and assumes the relaxed condition of the mounting position. Groove 13 captures the major axis DL of each leg 62′, 64′, between parallel walls formed by the groove 13. Since each leg is now trapped between the parallel walls of groove 13, no further movement of the endform 14 in direction A can occur. The groove 13 acts to latch the endform 14 to the receptacle preventing the endform 14 from being physically pulled out of the receptacle or dislodged by internal pressure applied to the quick connector by the fluid flowing within.

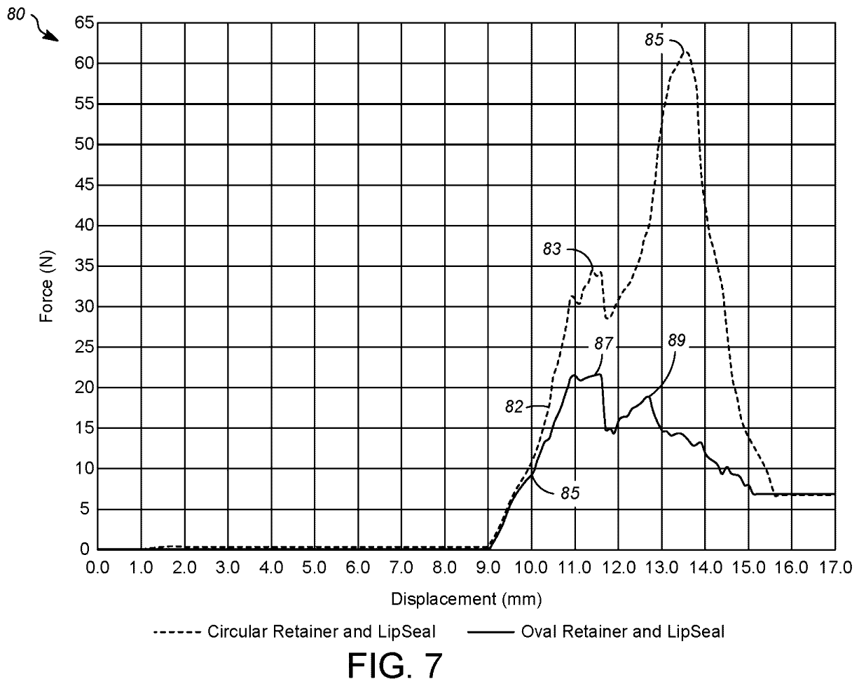

Turning now to FIG. 7 a graph 80 is shown that compares the insertion forces for the low insertion force oval 63′ wire retainer 60′ and the prior art round 63 wire retainer 60. The graph 80 charts insertion force Newtons (N) to displacement in millimeters (mm) of the endform 14 in direction A during the installation of the endform 14 into the receptacle. Graph lines 82 and 85 illustrate the amount of insertion force required for the displacement of the endform 14 when installed in the receptacle. The displacement from 0.0 mm to 9.0 mm represents the endform 14 in the mounting position. The displacement from 9.0 mm to 15.0 represents the endform 14 in the transitional position and the displacement from 15.0 mm to 17.0 mm in the latched position.

Graph line 82 represents the insertion force required to be applied to the endform 14 in direction A when using a round 63 wire retainer 60, having a cross-section D illustrated in FIG. 2A. Graph line 82 includes a first insertion force peak 83 of 34.3 N at 11.5 mm of displacement and a second insertion force peak 85 of 61.2 N at 13.5 mm of displacement. The insertion force of the first insertion force peak 83 is caused to the greatest extent by insertion of the end portion 15 in the O-ring 76, with a smaller force caused by the legs 62, 64 due to the beginning displacement of legs 62, 64 by ramped surface 11 during the transitional position. The second insertion force peak 85 is caused to a great extent by legs 62, 64 reaching edge 111 of ramped surface 11 with a small force caused by the O-ring 76 during the transitional position.

The graph line 85 represents the insertion force required to be applied to the endform 14 when using the low insertion force oval 63′ wire retainer 60′ having a cross-section of a short diameter axis DS and a long diameter axis DL illustrated in FIG. 3A. The graph line 85 includes a first insertion force peak 87 of 21.5 N at approximately 11.5 mm of displacement and a second insertion force peak 89 of 18.9 N at approximately 12.7 mm of displacement. Again, as explained above, the insertion force of the first insertion force peak 87 is caused to the greatest extent by insertion of the end portion 15 in the O-ring 76 with a smaller force caused by the legs 62′, 64′ starting to be displaced by ramped surface 11 during the transition position. The second insertion force peak 89 is caused largely by legs 62′, 64′ reaching edge 111 with a small force caused by the O-ring 76 during the transition position. Therefore, graph 80 shows that the low insertion force oval 63′ wire retainer 60′ of the present disclosure requires a much lower insertion force to install the endform 14 into the receptacle of a quick connector 10 than the round 63 wire retainer 60.

While the following is described in conjunction with specific embodiments, it will be understood that this description is intended to illustrate and not limit the scope of the preceding description and the appended claims.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A connector for coupling to a tube comprising:
a receptacle having an interior cavity arranged to receive the tube; and
a retainer embracing the receptacle, having at least a first leg positioned in a cavity located in the interior of the receptacle that engages the tube when the tube is inserted into the cavity, wherein the first leg has a cross-section that has a first minor axis that is smaller than a second major axis.

2. The connector of claim 1, wherein the retainer has a second leg positioned in the cavity on an opposite side and in a spaced relationship from the first leg, the second leg engages the tube when the tube is inserted into the interior cavity, the second leg having a cross section that has a first minor axis that is smaller than a second major axis.

3. The connector of claim 2, wherein each first and second leg extends from opposite ends of a bite to form a U-shaped assembly, wherein the bite has a cross-section having a first minor axis that is smaller than a second major axis conforming to the cross-section of the first and second legs.

4. The connector of claim 3, wherein the receptacle includes first and second slots formed on opposing walls of the receptacle, the first leg extending into the cavity through the first slot and the second leg extending into the cavity through the second slot, with the minor axis of each first and second leg oriented towards the interior cavity of the receptacle.

5. The connector of claim 3, wherein the minor axis is 20 percent to 30 percent smaller than the major axis.

6. The connector of claim 3, wherein the major axis of each first and second leg is parallel with the longitudinal axis of the receptacle interior cavity.

7. The connector of claim 3, wherein the tube includes an annular groove extending circumferentially about a peripheral surface of the tube, the groove having parallel spaced walls that accept the major axis of each first and second leg.

8. The connector of claim 3, wherein the U-shaped assembly is a wire retainer composed of a steel material.

9. An assembly of a connector and a tube, the assembly comprising:
a receptacle;
an endform formed on the end of the tube including a groove extending about the periphery of the endform, the endform inserted into a cavity within the receptacle in a mounting position and slidable into a latched position;
a retainer embracing the receptacle having first and second legs extending into the cavity, each leg having a cross section that has a first minor axis and a second major axis; and
the endform engaging the first and second legs first minor axis urging the first and second legs into a spread condition while the endform is sliding from the mounting position into the latched position, wherein in the latched position the first and second legs of the retainer are captured in the groove when the first and second legs retract to a relaxed condition.

10. The assembly of claim 9, wherein the receptacle includes first and second slots formed on opposing walls of the receptacle, the first leg extending into the cavity through the first slot and the second leg extending into the cavity through the second slot, with the minor axis of each first and second leg oriented towards the cavity of the receptacle.

11. The assembly of claim 10, wherein each first and second leg is urged outward of their associated first and second slot when the endform slides from the mounting position into the latched position.

12. The assembly of claim 9, wherein the major axis of each first and second leg is parallel with the longitudinal axis of the receptacle interior cavity.

13. The assembly of claim 9, wherein the groove has spaced parallel walls that accept the major axis of each first and second leg between the walls when in the relaxed condition in the latched position.

14. The assembly of claim 10, wherein the endform includes a ramped surface that engages each first and second leg and that urges each leg into the spread condition when the endform traverses from the mounting position into the latched position.

15. The assembly of claim 9, wherein the first minor axis is smaller than the second major axis.

16. The assembly of claim 15, wherein the minor axis is 20 to 30 percent smaller than the major axis.

17. The assembly of claim 9, wherein each first and second leg extends from opposite ends a bite to form a U-shaped assembly, wherein the bite has a cross-section having a first minor axis smaller than the second major axis conforming to the cross-section of the first and second legs.

18. The assembly of claim 17, wherein the U-shaped assembly is a wire retainer composed of a steel material.

19. A process for coupling a tube to a receptacle comprising:
forming an endform on an end of the tube, the endform having a groove about the periphery of the endform and locating the endform in a cavity within the receptacle in a mounting position, the endform slidable into a latched position;
installing a retainer having a first and a second legs in the cavity, each leg having a cross section that has a first minor axis and a second major axis;
sliding the endform from the mounting position to the latched position causing the endform to engage the first and second legs minor axis that urge the first and second legs into a spread condition while the endform is traversing from the mounting position to the latched position, wherein in the latched position the major axis of each of the first and second legs are captured by parallel walls forming the groove when the first and second legs retract to a relaxed condition.

20. The process of claim 19, wherein the first minor axis is smaller by 20-30 percent than the second major axis.
